(19) United States
(12) Patent Application Publication
(10) Pub. No.: US 2015/0242899 A1
(43) Pub. Date: Aug. 27, 2015

(54) SYSTEMS AND METHODS FOR CUSTOMER MOVEMENT TRACKING ANALYTICS

(71) Applicant: Adam Farhi, Tel Aviv (IL)

(72) Inventor: Adam Farhi, Tel Aviv (IL)

(21) Appl. No.: 14/192,462

(22) Filed: Feb. 27, 2014

(51) Int. Cl. G06Q 30/02

(52) U.S. Cl. CPC G06Q 30/0261

(57) ABSTRACT

A system or method is provided to monitor a consumer's locations and movements within a store. In particular, the locations and movements of the consumer in a merchant's store may be monitored using a network of Bluetooth beacons installed throughout the merchant's store. Based on the BLE signals detected at the consumer's mobile device, the location of the consumer in the store may be determined by triangulation by referencing the designated positions of the BLE beacons that emits the BLE signals. In an embodiment, the consumer's locations and movement in the store may be collected and analyzed to generate consumer traffic heat maps in the store. Based on the traffic heat maps, locations may be determined to better facilitate product placement. Further, the shopping routes of the consumer may be analyzed to generate in-store advertisements which are presented to the consumer along the consumer's shopping route.

### BACKGROUND

1. Field of the Invention

The present invention generally relates to systems and methods for implementing customer movement tracking analysis.

2. Related Art

The digital footprints of consumers have been collected and utilized to generate market analysis. For example, a consumer's online browsing or purchase history can be used to determine consumer demographic, purchase preference, interests, and the like to help online merchants better target specific group of consumers for sales promotion. Nevertheless, footprints of consumers shopping or browsing in a brick-and-mortar store are difficult to detect. As such, it is difficult to collect consumers' browsing or shopping habits in brick-and-mortar stores. Thus, there is a need for a system or method that helps facilitate tracking and analysis of customer movements in brick-and-mortar stores.

### BRIEF DESCRIPTION OF THE FIGURES

FIG. 1 is a block diagram of a networked system suitable for implementing customer movement tracking analysis according to an embodiment.

FIG. 2 is a flowchart showing a process for monitoring and storing customer movements in a store according to one embodiment.

FIG. 3A is a flowchart showing a process for generating product placement according to one embodiment.

FIG. 3B is a flowchart showing a process for generating in-store advertisements according to one embodiment.

FIG. 4 is a block diagram of a computer system suitable for implementing one or more components in FIG. 1 according to one embodiment.

FIG. 5 is a diagram depicting a floor layout of a merchant store according to one embodiment.

FIG. 6 is a diagram depicting a network of beacons according to one embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

According to an embodiment, a system or method is provided to detect and monitor a consumer's movement in a merchant's store. In particular, the location and movement of the consumer in the merchant's store may be monitored by detecting a location of the consumer's mobile device via Bluetooth Low Energy (BLE) communication using a network of BLE devices, such as beacons, positioned throughout the merchant's store. Based on the BLE signals detected at the consumer's mobile device, the location of the consumer in the store may be determined by triangulation and by referencing the designated positions of the BLE beacons that emits the BLE signals.

In an embodiment, the consumer's locations and movements in the store may be collected and analyzed to generate consumer traffic heat maps in the store. Based on the traffic heat maps, various locations may be identified for better product placement and store layout. Further, the shopping routes of the consumer may be analyzed to generate in-store advertisements. The in-store advertisement may be presented to the consumer along the consumer's shopping route to entice the consumer to purchase certain products.

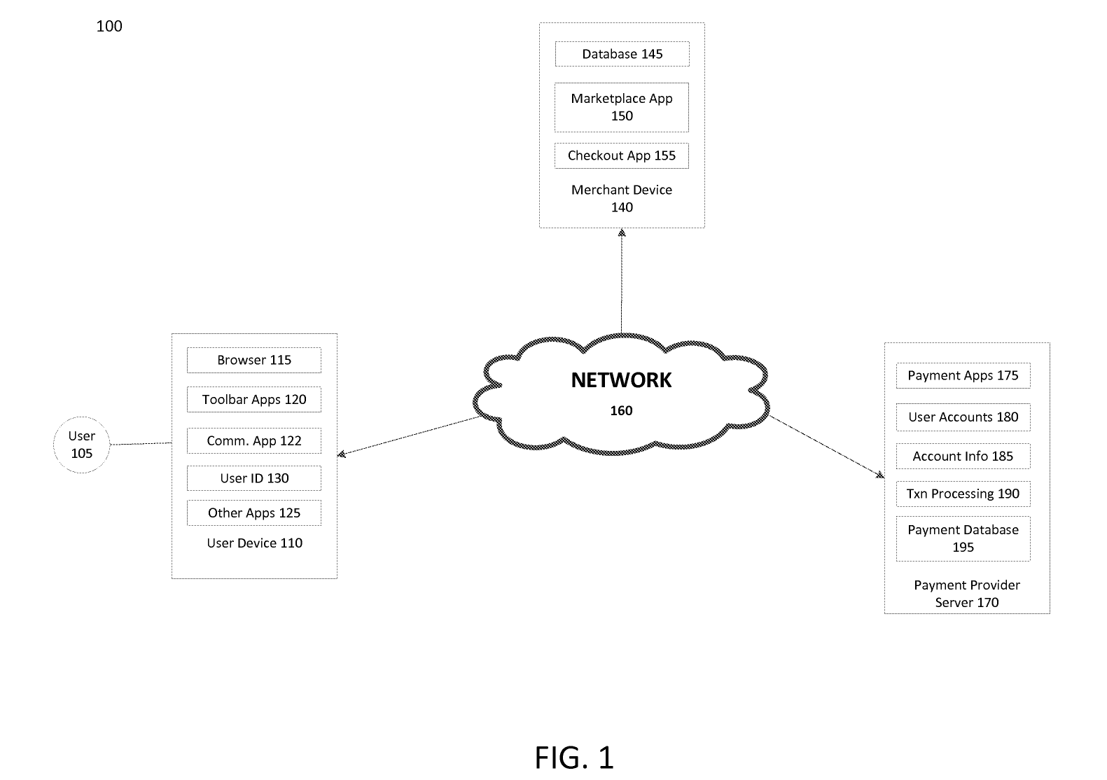

FIG. 1 is a block diagram of a networked system 100 suitable for implementing a process for implementing customer movement tracking analysis according to an embodiment. Networked system 100 may comprise or implement a plurality of servers and/or software components that operate to perform various payment transactions or processes. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

System 100 may include a user device 110, a merchant server 140, and a payment provider server 170 in communication over a network 160. Payment provider server 170 may be maintained by a payment service provider, such as PayPal, Inc. of San Jose, Calif. A user 105, such as a sender or consumer, utilizes user device 110 to perform a transaction using payment provider server 170. User 105 may utilize user device 110 to initiate a payment transaction, receive a transaction approval request, or reply to the request. Note that transaction, as used herein, refers to any suitable action performed using the user device, including payments, transfer of information, display of information, etc. For example, user 105 may utilize user device 110 to initiate a deposit into a savings account. Although only one merchant server is shown, a plurality of merchant servers may be utilized if the user is purchasing products or services from multiple merchants.

In some embodiments, user device 110 may download a shopping application from payment provider server 170 or from merchant server 140. The shopping application may allow user 105 to compose shopping lists listing items to be purchased at the merchant's store. User device 110 may include a Bluetooth device configured to implement low energy Bluetooth communication. A network of low energy Bluetooth beacons may be installed at various locations inside the merchant's store. Thus, the location and movements of user device 110 in the merchant's store may be determined by detecting the various Bluetooth beacons installed in the merchant's store. When user 104 utilizes the shopping application on user device 110 to purchase items on a shopping list, the locations and movements of user 104 in the merchant's store may be monitored.

User device 110, merchant server 140, and payment provider server 170 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160. Network 160 may be implemented as a single network or a combination of multiple networks. For example, in various embodiments, network 160 may include the Internet or one or more intranets, landline networks, wireless networks, and/or other appropriate types of networks.

User device 110 may be implemented using any appropriate hardware and software configured for wired and/or wireless communication over network 160. For example, in one embodiment, user device 110 may be implemented as a personal computer (PC), a smart phone, personal digital assistant (PDA), laptop computer, and/or other types of computing devices capable of transmitting and/or receiving data, such as an iPad™ from Apple™.

User device 110 may include one or more browser applications 115 which may be used, for example, to provide a convenient interface to permit user 105 to browse information available over network 160. For example, in one embodiment, browser application 115 may be implemented as a web browser configured to view information available over the Internet, such as a user account for setting up a shopping list and/or merchant sites for viewing and purchasing products and services. User device 110 may also include one or more toolbar applications 120 which may be used, for example, to provide client-side processing for performing desired tasks in response to operations selected by user 105. In one embodiment, toolbar application 120 may display a user interface in connection with browser application 115.

User device 110 may further include other applications 125 as may be desired in particular embodiments to provide desired features to user device 110. For example, other applications 125 may include security applications for implementing client-side security features, programmatic client applications for interfacing with appropriate application programming interfaces (APIs) over network 160, or other types of applications.

Applications 125 may also include email, texting, voice and TM applications that allow user 105 to send and receive emails, calls, and texts through network 160, as well as applications that enable the user to communicate, transfer information, make payments, and otherwise utilize a smart wallet through the payment provider as discussed above. User device 110 includes one or more user identifiers 130 which may be implemented, for example, as operating system registry entries, cookies associated with browser application 115, identifiers associated with hardware of user device 110, or other appropriate identifiers, such as used for payment/user/device authentication. In one embodiment, user identifier 130 may be used by a payment service provider to associate user 105 with a particular account maintained by the payment provider. A communications application 122, with associated interfaces, enables user device 110 to communicate within system 100.

User device 110 may include a Bluetooth device configured to implement low energy Bluetooth (BLE) communication. For example, user device 110 may detect various low energy Bluetooth signals from Bluetooth beacons installed in a merchant's store. Thus, locations and movements of user device 110 may be determined by positioning techniques, such as triangulation or location fingerprinting.

Merchant server 140 may be maintained, for example, by a merchant or seller offering various products and/or services. The merchant may have a physical point-of-sale (POS) store front. The merchant may be a participating merchant who has a merchant account with the payment service provider. Merchant server 140 may be used for POS or online purchases and transactions. Generally, merchant server 140 may be maintained by anyone or any entity that receives money, which includes charities as well as banks and retailers. For example, a payment may be a donation to charity or a deposit to a saving account. Merchant server 140 may include a database 145 identifying available products (including digital goods) and/or services (e.g., collectively referred to as items) which may be made available for viewing and purchase by user 105. Accordingly, merchant server 140 also may include a marketplace application 150 which may be configured to serve information over network 160 to browser 115 of user device 110. In one embodiment, user 105 may interact with marketplace application 150 through browser applications over network 160 in order to view various products, food items, or services identified in database 145.

Merchant server 140 also may include a checkout application 155 which may be configured to facilitate the purchase by user 105 of goods or services online or at a physical POS or store front. Checkout application 155 may be configured to accept payment information from or on behalf of user 105 through payment service provider server 170 over network 160. For example, checkout application 155 may receive and process a payment confirmation from payment service provider server 170, as well as transmit transaction information to the payment provider and receive information from the payment provider (e.g., a transaction ID). Checkout application 155 may be configured to receive payment via a plurality of payment methods including cash, credit cards, debit cards, checks, money orders, or the like.

Merchant server 140 may be connected to a network of Bluetooth beacons installed in the merchant's brick-and-mortar store. The network of Bluetooth beacons may be installed at respective locations throughout the merchant's store to form a grid. Each Bluetooth beacon may emit a low energy Bluetooth signal in specific frequency spectrum periodically. Thus, the network of Bluetooth may allow detection of locations and movements of consumer in the merchant's store. In some embodiments, merchant server 140 may maintain a database that stores shopping routes taken by consumers. The shopping routes may be routes taken by the consumers when browsing or shopping in the merchant's store.

Payment provider server 170 may be maintained, for example, by an online payment service provider which may provide payment between user 105 and the operator of merchant server 140. In this regard, payment provider server 170 includes one or more payment applications 175 which may be configured to interact with user device 110 and/or merchant server 140 over network 160 to facilitate the purchase of goods or services, communicate/display information, and send payments by user 105 of user device 110.

Payment provider server 170 also maintains a plurality of user accounts 180, each of which may include account information 185 associated with consumers, merchants, and funding sources, such as banks or credit card companies. For example, account information 185 may include private financial information of users of devices such as account numbers, passwords, device identifiers, user names, phone numbers, credit card information, bank information, or other financial information which may be used to facilitate online transactions by user 105. Advantageously, payment application 175 may be configured to interact with merchant server 140 on behalf of user 105 during a transaction with checkout application 155 to track and manage purchases made by users and which and when funding sources are used.

In some embodiments, payment provider server 170 may maintain a database including shopping lists and routes associated with each user. The shopping lists may be created by users for items that are to be purchased at a merchant. The shopping routes are routes taken by users when the users are shopping in a merchant's store. The database may organize the shopping routes and shopping lists by each user or by each merchant. Payment provider server 170 may periodically update the shopping lists and shopping routes to add new shopping lists created by the uses and shopping routes taken by the users.

A transaction processing application 190, which may be part of payment application 175 or separate, may be configured to receive information from user device 110 and/or merchant server 140 for processing and storage in a payment database 195. Transaction processing application 190 may include one or more applications to process information from user 105 for processing an order and payment using various selected funding instruments, including for initial purchase and payment after purchase as described herein. As such, transaction processing application 190 may store details of an order from individual users, including funding source used, credit options available, etc. Payment application 175 may be further configured to determine the existence of and to manage accounts for user 105, as well as create new accounts if necessary.

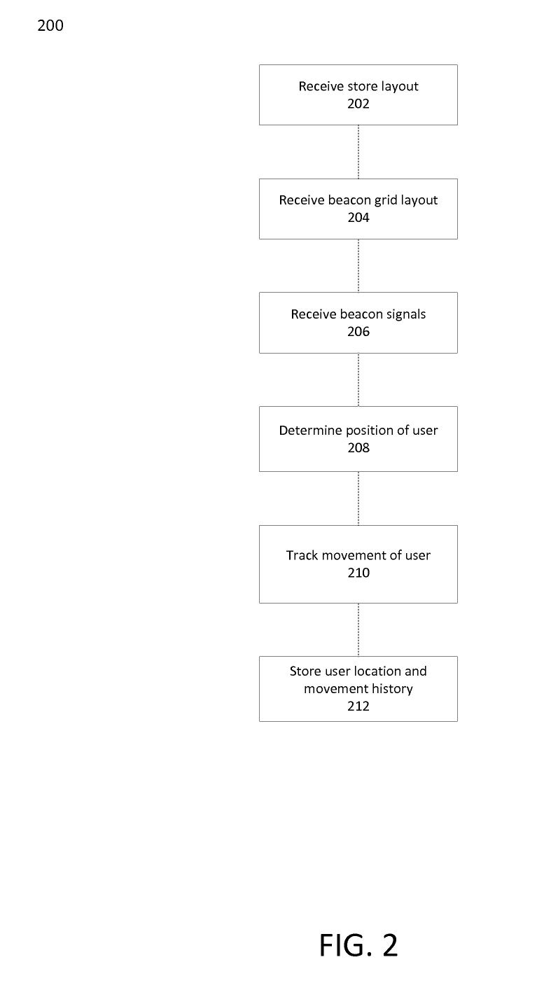

FIG. 2 is a flowchart showing a process 200 for monitoring and storing customer movements in a store according to one embodiment. At step 202, user device 110 or payment provider server 170 may receive various store layouts of various merchants' stores. For example, store layouts for grocery stores, retail stores, restaurants, museums, or other public places visited by consumers may be received by user device 110 or payment provider server 170. Each layout may include a profile indicating the name of the merchant or owner, the address, contact information, type of business, products or services offered, and other information related to the store. Payment provider server 170 may store the various store layouts in a database each with its own profile.

At step 204, user device 110 or payment provider server 170 may receive layouts of networks of beacons corresponding to the store layouts received in step 202. The beacon layouts may be merged with their corresponding store layouts, such that the coordinate of each beacon in the beacon grid may be designated. For example, a network of Bluetooth beacons may be installed in the merchant's store. Each Bluetooth beacon may be installed at a specific location in the merchant's store and may emit low energy Bluetooth signals. Thus, a network of Bluetooth beacons may be formed in the merchant's store.

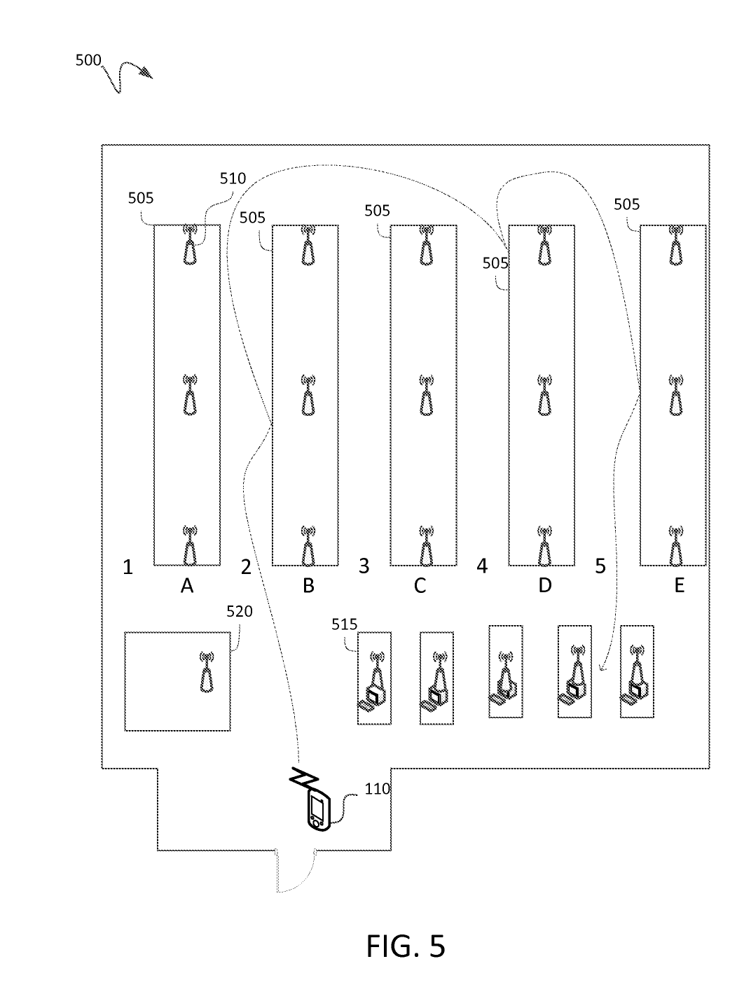

As shown in FIG. 5, as an example, the store layout of a grocery merchant may include selves 505. Each shelf 505 in the store may have three Bluetooth beacons 510: one at the front section, one at the middle section, and one at the rear section. Each checkout counter 515 also may have a Bluetooth beacon 510. Further, one Bluetooth beacon 510 may be installed at a customer service counter 520 near the entrance of the store. The network of Bluetooth beacons 510 may be connected to merchant device 140. Each Bluetooth beacon 510 may emit a low energy Bluetooth signal with specific frequency spectrum. User 105 may carry a user device 110 including a Bluetooth device configured to communicate via low energy Bluetooth communication. When user 105 enters the merchant's store, user device 110 may detect Bluetooth beacons 510 installed near the store's entrance, such as the Bluetooth beacon 510 at customer service counter 520 and the Bluetooth beacon 510 at a checkout counter 515. Thus, the position of user device 110 may be determined based on which Bluetooth signals are received and the respective signal strength of the signals.

At step 206, user device 110 may receive Bluetooth signals from one or more of the beacons from the network of beacons installed at the merchant's store. Each Bluetooth beacon installed at the merchant's store may emit a unique signal. A Bluetooth beacon database may be used to store profiles for each Bluetooth beacon. For example, each Bluetooth beacon may have a profile containing the Bluetooth beacon's location in the store, the unique signal signature of the beacon, the signal strength of the beacon, and the like. When user device 110 is at a certain location in the merchant's store, user device 110 may receive one or more Bluetooth signals emitted from Bluetooth beacons located near user device 110.

At step 208, the position of user device 110 may be determined based on the Bluetooth signals received at user device 110 using techniques, such as triangulation or location fingerprint. In the triangulation technique, the location of user device 110 may be determined based on the locations of three Bluetooth beacons 510 and the distance of user device 110 from the two or more Bluetooth beacons 510. The locations of the Bluetooth beacons 510 may be predetermined when the Bluetooth beacons 510 are installed on the shopping floor of the store. The distance between the Bluetooth beacons 510 and user device 110 may be determined based on the signal strength received between the Bluetooth beacons 510 and user device 110. A stronger signal may indicate a shorter distance while a weaker signal may indicate a longer distance. Thus, based on the Bluetooth signals between the Bluetooth beacons 510 and user device 110, the location of user device 110 may be determined using the triangulation technique.

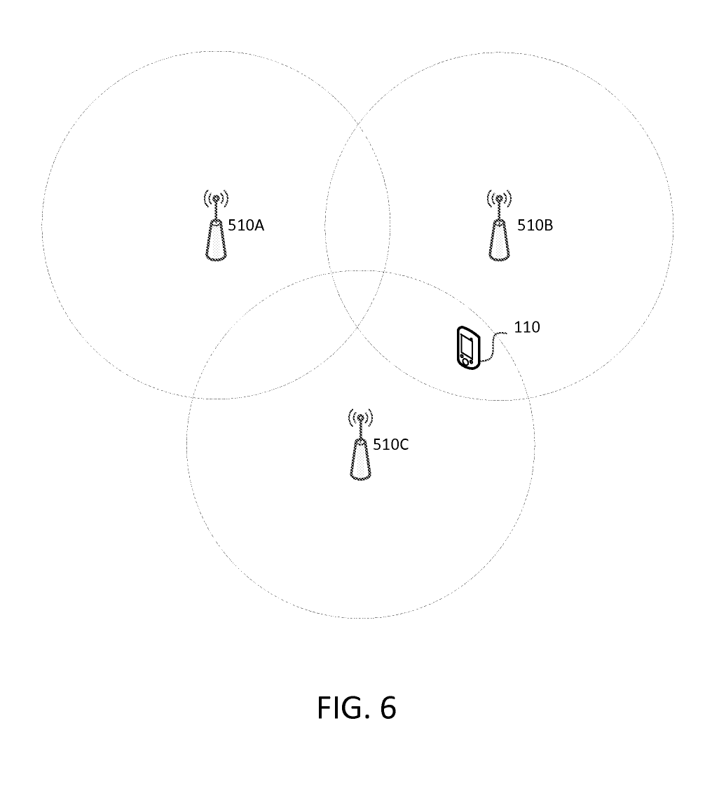

For example, as shown in FIG. 6, three Bluetooth beacons 510A, 510B, and 510C may each emit a unique Bluetooth signal. The signal range of each beacon may be illustrated as a circle of dashed line surrounding each beacon. As shown in FIG. 6, user device 110 may be located at a position at which user device 110 receives signals from beacon 510B and beacon 510C, but not beacon 510A. In particular, user device 110 receives signals with about the same signal strength from both beacons 510B and 510C. Thus, user device 110 is located between an area between beacons 510B and 510C, but away from 510A. Further, based on the signal strengths of the signals, the distance between user device 110 and beacons 510B and 510C may be determined. User device 110 or payment provider server 170 may analyze the signals and their signal strengths received at user device 110 and reference the locations of the beacons that emit these signals to determine the location of user device 110 by triangulation techniques.

In the location fingerprint technique, a database of signal fingerprints at various locations on the shopping floor may be predetermined. For example, a signal profile may be predetermined for each location. The signal profile may include Bluetooth signals that are detected at that location and the strength of each of those detected Bluetooth signals. For example, as shown in FIG. 6, when user device 110 is positioned at a certain position between beacons 510B and 510C, a signal profile may be predetermined to indicate medium signals from beacons 510B and 510C and low or no signal from beacon 510A. A database of signal profiles associated with a plurality of respective locations on the shopping floor may be predetermined and stored. Thus, based on a signal profile detected by user device 110, a location of user device 110 may be determined by referencing the database of signal profiles.

In some embodiments, the signal profile may be the Bluetooth signal of user device 110 received by respective Bluetooth beacons. For example, as shown in FIG. 6, when user device 110 is positioned between beacons 510B and 510C, a signal profile may be predetermined to indicate medium signals received by beacons 510B and 510C, and weak or no signal received at beacon 510A. Thus, the signal fingerprints may be signals received by user device 110 or signals received by the respective Bluetooth beacons 510.

The location of user device 110 may be determined by user device 110. For example, user device 110 may download a layout map of the merchant and may determine user device 110's position based on the Bluetooth signals detected and the floor layout of the Bluetooth beacons 510. In some embodiments, merchant device 140 may determine the location of user device 110 based on which Bluetooth beacons 510 detect user device 110 and the strength of the signal detected at the Bluetooth beacons 510. In some embodiments, the detected signals and signal strengths may be forwarded to payment provider server 170 and payment provider server 170 may determine the location of user device.

At step 210, the movement of user device may be tracked. For example, the position of user device 110 may be monitored continuously, e.g., every few seconds or based on the frequency of the beacons used to obtain user location within the store, to track the movement of user device 110 in the store. Each location detection may be included with a time stamp. Thus, a movement of user 105 on the shopping floor may be monitored over time. By tracking the movement of consumers on the shopping floor, the consumers' shopping habits or preferences may be analyzed to improve shopping experience and increase sales. For example, by tracking consumer movements or shopping routes, the system may determine which routes are most and/or least taken by shoppers and where shoppers like to linger or spend time. These statistics may be used to improve floor layout and/or determine product placements. Advertisements also may be presented to the consumer at proper locations.

The time user 105 spends at various locations in the store also may be monitored. For example, user 105 may spend more time in a coffee section or coffee bar on Saturday mornings or spend more time in a wine section on Saturday late afternoon/early evening. The time of year, time, or day user 105 visits a particular location of the store also may be noted. For example, the time user 105 spends visiting a particular location of the store before or during a holiday or special event, such as Super Bowls, may be monitored. The time spent at a particular location in the store may be determined based on how long a user is detected to enter a wireless signal range of a Bluetooth beacon till when the user departs from the wireless signal range of that Bluetooth beacon.

At step 212, the location and movement of user 105 in the store may be stored in a user preference database. For example, a shopping profile may be established for user 105 to store user's shopping habits or preferences at various stores. In particular, the location and movement of user 105 during a shopping trip and the items purchased during the shopping trip may be associated and stored in user 105's shopping profile. The shopping profile may continuously be updated as user 105 visits different stores. Thu, user's shopping habits and preferences may be monitored and analyzed.

Accordingly, process 200 may be used to detect, track, and monitor consumers' locations and movements in various merchants' stores. This information combined with information regarding what are the items eventually purchased by the consumers may be used to analyze consumers' shopping habits and preferences to improve shopping experience and increase sales. The information may be for a specific consumer such that a particular consumer's movements through a store are analyzed, such as to be able to predict the consumer's path the next time the consumer is in the store. For example, a consumer may take a similar path through the store on Sunday nights, but a different path on Saturday mornings. Individual consumer paths may be based on specific times, days, etc. or may be aggregated into a single average path through the store regardless of time, day, etc. The information may also be used to average paths of different consumers (which can be on different times, days, etc. or overall) to provide the store an idea of how a general or average consumer navigates through the store.

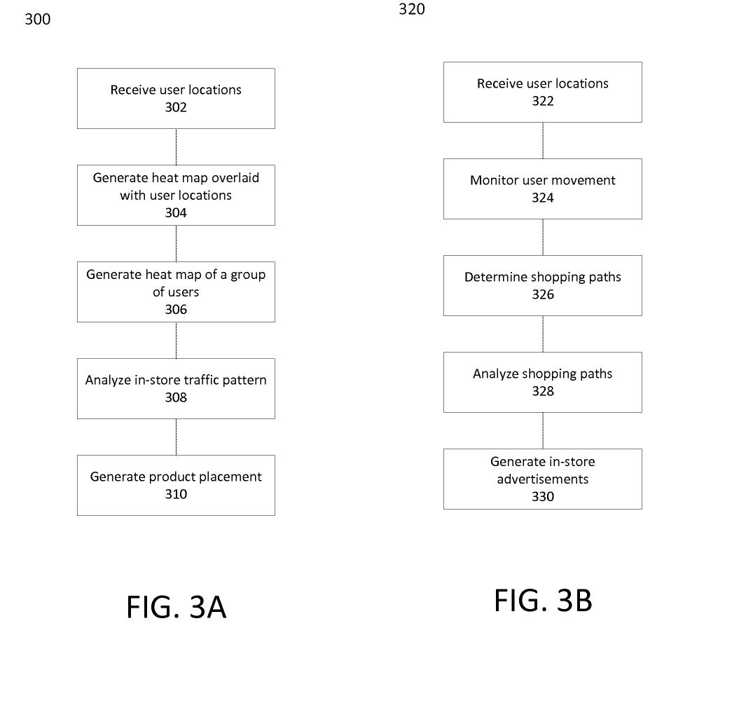

FIG. 3A is a flowchart showing a process 300 for generating product placement according to one embodiment. At step 302, merchant device 140 or payment provider server 170 may receive user 105's locations in a merchant's store. For example, as noted above, the locations where user 105 has visited in merchant's store and time spent at various locations may be accessed from user 105's shopping profile.

At step 304, a heat map including various colors may be generated to show frequencies of visits and/or time spent at various locations of the store. The frequencies of visits may be indicated by different colors. For example, more frequently visited area may be indicated with darker colors while less frequently visited area may be indicated by lighter colors. The heat map may be generated to show where user 105 most and least visited locations in the store. The amount of time spent at each location may also be indicated by different colors. In an embodiment, a heat map may be generated to show areas of the store where user 105 spend time or linger. In an embodiment, the heat map may be generated from locations visited by all customers who have visited the store. Thus, a traffic heat map of the store may be generated to show locations where customers have frequented.

In some embodiments, heat maps may be generated for customers of different demographic groups. Different demographic groups may include different age ranges, purchase amount ranges, genders, incomes, interests, and the like. For example, a heat map may be generated to show locations where customers, who are age 50 or older, visit in the store. In another example, a heat map may be generated to show locations where customers, who purchased more than $50, visit in the store. Thus, heat maps for customers from various demographic groups may be generated.

At step 308, in-store traffic patterns may be analyzed. In particular, based on the movements of user 105 in the store, a general shopping route of user 105 may be determined. For example, user 105 may frequently enter the store and visit the dairy section, the produce section, the meat section, and then the checkout section, in that order. In some embodiments, movements of all customers may be analyzed to determine a general traffic flow of the shopping crowd. In another embodiment, the shopping routes of various demographic groups may be generated to determine general traffic flow of the specific demographic group. For example, data can be gathered to determine how customers who are age 20 or younger move through the store during a shopping trip.

At step 310, product placement recommendations may be generated based on the heap maps and traffic patterns. In particular, based on the heat maps showing locations where customers frequented, products may be placed to better entice customers to make purchases. For example, based on the heap map, certain “hot spots” may be identified as locations where customers most visited. These hot spots may be reserved for certain products that the merchant wishes to advertise to customers. In some embodiments, these hot spots may be reserved for products from manufacturers or distributers who paid a premium for their products to be placed in these hot spots.

Further, based on the heat map generated for different demographic groups, products target for these different demographic groups may be placed respectively at their respective hot spots. For example, if there is a certain hot spot where customers age 20 or younger likes to visit, products targeting customers age 20 or younger may be placed at or near this hot spot. In addition, product advertisements also may be placed at appropriate locations based on the heat map to target certain demographic groups. For example, advertisements for toys may be placed en-route or at hot spots where parents or children most likely to visit.

The heat maps or traffic patterns also may be used to identify customer traffic in the store. The traffic patterns may be noted to improve store layout and product placements, in order to avoid customer traffic congestions. For example, hot spots with products that attract customers may be placed away from each other, such that these hot spots do not attract excessive customer traffic within the same area to avoid traffic congestion. If the dairy section and the meat section are both popular hot spots, they may be placed at two different ends of the store to avoid excessive traffic in the same section of the store. Further, certain traffic bottlenecks may be identified and the shopping path for these traffic bottlenecks may be altered or widened to facilitate traffic.

Accordingly, heat maps or traffic patterns collected from various customers may be utilized to improve shopping experience and increase sales. In particular, heat maps and movement patterns of customers of various demographic groups may be utilized to better customize the product placement and the layout of the store to accommodate the various demographic groups. Traffic patterns also may be used to improve store layout to avoid congestions.

FIG. 3B is a flowchart showing a process 320 for generating in-store advertisements according to an embodiment. At step 322, merchant device 140 or payment provider server 170 may receive user 105's locations in a merchant's store. For example, as noted above, the locations where user 105 has visited in merchant's store may be accessed from user 105's shopping profile.

At step 324, user 105's movements in the store may be monitored. For example, the location of user 105 may continuously detected over time to plot a movement of user 105 in the store. At step 326, user 105's shopping paths may be determined based on the movements of user 105 during the shopping trip. In some embodiments, merchant device 140 may maintain a product placement database indicating where each product is placed in the store. Thus, how user 105 moves through the store and which items are purchased may be associated with the shopping trip. The shopping paths taken by user 105 and the items picked up along the shopping paths may be stored in user 105's shopping profile for future reference. At step 328, the shopping paths taken by user 105 may be analyzed. In particular, products that are placed along user 105's shopping paths may be identified based on the product placement database.

At step 330, in-store advertisements may be generated for user 105 based on user's preferences, interests, and user 105's shopping paths, In particular, user's preferences and interests may be derived from user's purchase history and/or user's demographic. For example, based on user's purchase of wine, the system may determine that user enjoys wine and other wine related merchandize, such as chesses. Further, items that are interesting to other customers with similar demographic as user 105 may also be of interest to user 105. In another example, items that are interesting to other customers, who take similar shopping paths as user 105's shopping paths, may also be of interest to user 105. In still another embodiment, products placed in a section of the store where user 105 has spent more time may be of interest to user 105.

After the items that may be of interest to user 105 are selected, advertisements may be generated for these items. The advertisements may describe the item that may be of interest to user 105 and how user 105 may be interested in purchasing it. The advertisements also may describe the location of the item. For example, “You have enjoyed a California Merlot last time. A new California Merlot just arrived this week. It's on Aisle 9 Section C.”

The advertisements may be presented to user 105 when user 105 is approaching or on his or her way to the items being advertised. For example, by tracking user 105's movement via BLE signals, when user 105 is approaching an item to be advertised to user 105, the advertisement may be displayed to user 105 at user device 110. In another embodiment, in-store displays may be installed at various locations in the store to display advertisements to user 105. When user 105 is detected to be approaching one of the in-store displays, the advertisements generated for user 105 may be displayed to user 105. In another embodiment, the advertisements may be presented as an audio advertisement with music.

By using the above process 300, a shopping route may be generated based on a shopping list to help navigate a consumer through a store. In particular, the shopping routes may be generated by crowd-sourcing based on other shopping routes taken by other consumers to generate a most efficient route. Further, other products related to the items on the shopping list may be suggested to the consumer to enhance shopping experience.

The above processes 200, 300, and 320 may be executed by user device 110. In some embodiments, the processes 200, 300, and 320 may be executed at merchant device 140 or payment provider server 170. In some other embodiments, above processes 200, 300, and 320 may be executed by one or more of user device 110, merchant device 140, and payment provider server 170 in coordination with each other.

The following are exemplary scenarios in which the above processes 200, 300, and 320 may be implemented.

### Example 1

Kwik-E-Mart is a grocery store in the town of Springfield. Apu, the owner of Kwik-E-Mart, decides to install a network of BLE beacons in the store to monitor and track customer locations and movements. FIG. 5 is a floor layout of Kwik-E-Mart including the positions of various BLE beacons. Kwik-E-Mart has a shopping application, which is downloadable by customers onto their mobile devices. When customers are shopping in the store, the position and movements of the customers may be detected via the BLE beacons by detecting their mobile devices.

After a few months of collecting customer movements in the store, Kwik-E-Mart has obtained enough data to determine customer preferences. In particular, a heat map is generated to show general customer traffic. The heat map shows that, when customers enter the store, most customers walk down aisle 2 before heading to other locations, as shown in FIG. 5. Thus, aisle 2 may be very congested during busy hours when a lot of customers are entering the store. For this reason, Kwik-E-Mart decides to rearrange the selves to widen aisle 2 to improve traffic flow and customer shopping experience.

Further, traffic patterns show that the back side of aisle 2 is a hot spot where most customers pass through and is a prime location for placing hot items for sale. Thus, Kwik-E-Mart decides to offer this hotspot as a display area for products that the manufacturer or distributor would pay a premium for. Thus, Kwik-E-Mart offers this hot spot for bidding among product manufacturers and give the hot spot to the highest bidder, who is willing to pay a premium to place their products in the hot spot. Thus, by tracking the locations and movements of customers in the store, Kwik-E-Mart is able to better understand customers' shopping preferences and dynamics to improve shopping experience and to improve utility of various locations in the store.

### Example 2

Amy is a frequent customer at Kwik-E-Mart and uses her mobile device to help her navigate through Kwik-E-Mart. Based on Amy's previous shopping trips, a shopping route is determined as her usual or typical shopping route. As shown in FIG. 5, Amy typically enters the store, walks down aisle 2, through the path in the back, picks up milk at the dairy section at the back of aisle 4, then walks to the front through aisle 5, and checks out at the cashier.

Based on Amy's purchase history, Kwik-E-Mart determines that Amy may be interested in a new yogurt product. The yogurt product is placed along aisle 5. Thus, Kwik-E-Mart generates an advertisement for this new yogurt product. When Amy again goes to shop at Kwik-E-Mart and as Amy is walking down aisle 5, the system sends the advertisement to Amy stating: “A new yogurt product has been introduced. Check it out at aisle 5 section C. Introductory discount is included if purchased today!” Amy finds the new yogurt product in aisle 5 as indicated in the advertisement and decides to try it out. Thus, Amy picks up the new yogurt while walking down aisle 5 on her way to the register. Accordingly, by detecting a customer's movements, advertisements for various products may be presented to customers in real time during a shopping trip.

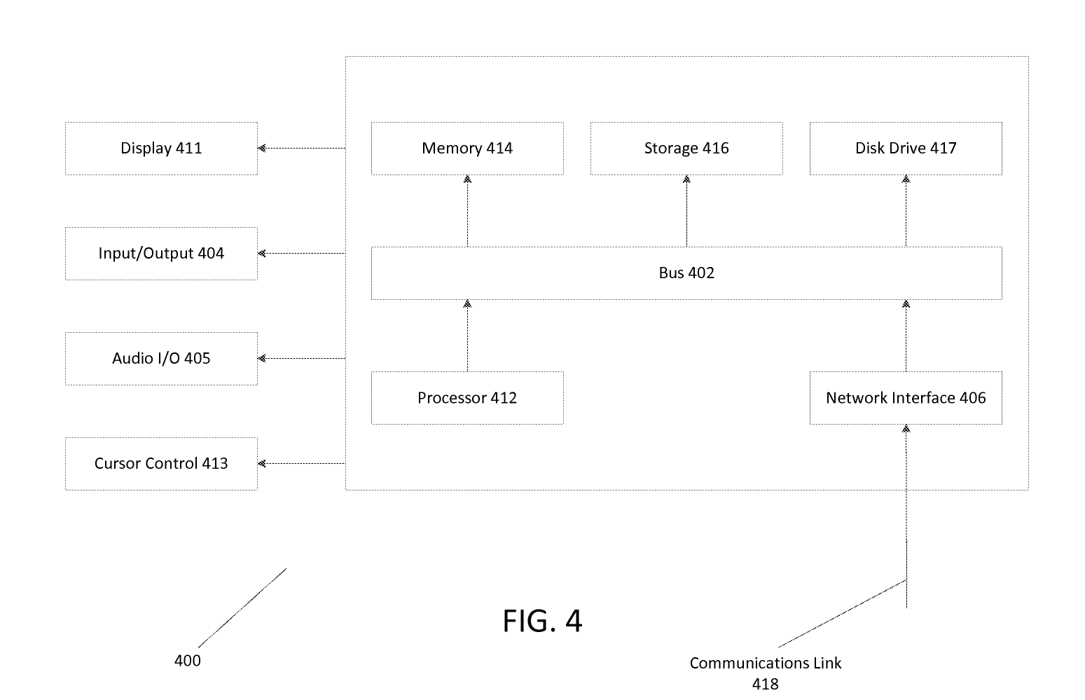

FIG. 4 is a block diagram of a computer system 400 suitable for implementing one or more embodiments of the present disclosure. In various implementations, the user device may comprise a personal computing device (e.g., smart phone, a computing tablet, a personal computer, laptop, PDA, Bluetooth device, key FOB, badge, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 400 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons or links, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as another user device, a merchant server, or a payment provider server via network 160. In one embodiment, the transmission is wireless, although other transmission mediums and methods may also be suitable. A processor 412, which can be a micro-controller, digital signal processor (DSP), or other processing component, processes these various signals, such as for display on computer system 400 or transmission to other devices via a communication link 418. Processor 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor 412 and other components by executing one or more sequences of instructions contained in system memory component 414. Logic may be encoded in a computer readable medium, which may refer to any medium that participates in providing instructions to processor 412 for execution. Such a medium may take many forms, including but not limited to, non-volatile media, volatile media, and transmission media. In various implementations, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 418 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein,

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a memory storing information about a user account including shopping preferences; and
one or more processors in communication with the memory and adapted to:
monitor a movement of a user by detecting a location of the user's communication device in a merchant store using a network of Bluetooth beacons;
determine a general shopping route taken by the user;
identify an item placed along the general shopping route;
generate an advertisement for the item; and
present the advertisement to the user when the user approaches the item.

2. The system of claim 1, wherein the location and movement of the communication device is determined by triangulation technique or by location fingerprint technique.

3. The system of claim 1, wherein the one or more processors are further adapted to:
monitor movements of customers using the network of Bluetooth beacons;
generate a heat map indicating frequencies various locations are visited by the customers; and
generate a product placement recommendation based on the heat map.

4. The system of claim 1, wherein the advertisement is displayed on the user's communication device.

5. The system of claim 1, wherein the advertisement is displayed on an in-store display installed near the item.

6. The system of claim 1, wherein the item is identified based on the user's purchase history.

7. The system of claim 1, wherein the one or more processors are further adapted to:
generate a heat map indicating length of time spent by the customer at various locations of the store; and
identify the item from items placed in a location of store where the customer spent the most time.

8. A method comprising:
monitoring, by a hardware processor, a movement of a user by detecting a location of the user's communication device in a merchant store using a network of Bluetooth beacons;
determining, by the hardware processor, a general shopping route taken by the user;
identifying, by the hardware processor, an item placed along the general shopping route;
generating, by the hardware processor, an advertisement for the item; and
presenting, by the hardware processor, the advertisement to the user when the user approaches the item.

9. The method of claim 8, wherein the location and movement of the communication device is determined by triangulation technique or by location fingerprint technique.

10. The method of claim 8 further comprising:
monitoring movements of customers using the network of Bluetooth beacons;
generate a heat map indicating frequencies various locations are visited by the customers; and
generating a product placement recommendation based on the heat map.

11. The method of claim 8, wherein the advertisement is displayed on the user's communication device.

12. The method of claim 8, wherein the advertisement is displayed on an in-store display installed near the item.

13. The method of claim 8, wherein the item is identified based on the user's purchase history.

14. The method of claim 8 further comprising:
generating a heat map indicating length of time spent by the customer at various locations of the store; and
identifying the item from items placed in a location of store where the customer spent the most time.

15. A non-transitory machine-readable medium comprising a plurality of machine-readable instructions which when executed by one or more processors are adapted to cause the one or more processors to perform a method comprising:
monitoring a movement of a user by detecting a location of the user's communication device in a merchant store using a network of Bluetooth beacons;
determining a general shopping route taken by the user;
identifying an item placed along the general shopping route;
generating an advertisement for the item; and
presenting the advertisement to the user when the user approaches the item.

16. The non-transitory machine-readable medium of claim 15, wherein the location and movement of the communication device is determined by triangulation technique or by location fingerprint technique.

17. The non-transitory machine-readable medium of claim 15, wherein the method further comprising:
monitoring movements of customers using the network of Bluetooth beacons;
generate a heat map indicating frequencies various locations are visited by the customers; and
generating a product placement recommendation based on the heat map.

18. The non-transitory machine-readable medium of claim 15, wherein the advertisement is displayed on the user's communication device.

19. The non-transitory machine-readable medium of claim 15, wherein the advertisement is displayed on an in-store display installed near the item.

20. The non-transitory machine-readable medium of claim 15, wherein the item is identified based on the user's purchase history.

21. The non-transitory machine-readable medium of claim 15, wherein the method further comprising:
generating a heat map indicating length of time spent by the customer at various locations of the store; and
identifying the item from items placed in a location of store where the customer spent the most time.
